(19) United States
(12) Patent Application Publication
(10) Pub. No.: US 2011/0021147 A1
(43) Pub. Date: Jan. 27, 2011

(54) SYSTEM AND METHOD FOR DETERMINING CONNECTIVITY STATUS OF SHORT RANGE WIRELESS DEVICES

(76) Inventor: Walid R. Tout, Ypsilanti, MI (US)

Correspondence Address: Brinks Hofer Gilson & Lione/Ann Arbor, 524 South Main Street, Suite 200, Ann Arbor, MI, 48104, US

(21) Appl. No.: 12/838,991

(22) Filed: Jul. 19, 2010

Related U.S. Application Data
(60) Provisional application No. 61/227,419, filed on Jul. 21, 2009.

(51) Int. Cl. H04B 5/00

(52) U.S. Cl. 455/41.2

(57) ABSTRACT

A method and apparatus for generating alerts once connectivity to a designated short range wireless (SRW) device is lost. Once connectivity is lost, an alert is sent to a master device (such as a mobile phone) notifying the master device user that connectivity to the designated SRW device has been lost. The master device user designates one or more paired SRW devices from a list of all paired SRW devices registered on the master device. For each SRW device of interest, a default or preferred alert method is chosen. The SRW devices of interest and their associated alert methods are saved in a file that resides either on the master device or a shared host device. A background process runs on the master or host device so as to read and parse the user's preferences and, accordingly, generates and sends alerts. For devices that support global system events and that expose SRW connectivity events, the background process intercepts those events associated with SRW devices of interest and generates alerts accordingly. For devices that do not support global system events or do not expose SRW connectivity events, the background process polls the connectivity with each SRW device of interest based on a pre-determined interval. If polling fails, indicating a lost connection, the appropriate alerts are triggered.

### CROSS REFERENCE TO RELATED APPLICATION

This application claims priority to provisional application No. 61/227,419, filed on Jul. 21, 2009, entitled PREVENT LOSS OF BLUETOOTH DEVICES, the entire contents of which is hereby incorporated by reference.

### BACKGROUND

1. Field of the Invention

The present invention relates generally to wireless communication. More specifically, the present invention relates to the monitoring and maintaining of connectivity between devices that use short range wireless (“SRW”) communication technology. It employs a notification mechanism that alerts SRW device users once connectivity with a SRW device of interest is lost.

2. Description of the Related Art

There are several different technologies and protocols by which devices can communicate with one another over short distances. One such protocol, known as BLUETOOTH™, employs the establishment of a short range ad-hoc network, known as a piconet. Under this protocol, utilizing radio frequency (RF) waves, generally in the 2.4 GHz range, up to seven devices can be simultaneously connected to one another to form the piconet. While BLUETOOTH™ is currently the most popular protocol, other systems/protocols exist for substantially achieving the same interconnectivity. As used herein, the term short range wireless (“SRW”) is intended to encompass all short range wireless communication technologies and devices employing radio or other waves to interconnect with one another in the formation of a short range, ad-hoc network of devices. Accordingly, the related terms like “SRW technology,” “SRW devices” and “SRW connectivity” are similarly used throughout the present specification. Regarding the term “short range,” this is intended to mean up to 300 feet, although many or most devices may have shorter ranges, such as ranges of only up to 33 feet.

Many applications exist where SRW connectivity between various SRW devices is enabled and established. For example, an SRW headset can be paired with an SRW technology equipped mobile phone, Smartphone or Personal Digital Assistant (PDA) to enable a mobile phone user to talk hands-free, without holding the phone next to the user's ear. Over the past few years, the number of SRW devices has noticeably increased. SRW technology is no longer only used for connecting headsets to mobile phones of one type or another, but also to connect computers, speakers, keyboards, computer mice (cursor pointing devices). When connectivity between one or more SRW devices is lost due to one of the devices either losing power or being moved out of SRW range, the ability of the device owner to become aware this connectivity loss is limited, unless the device is being used at the time connectivity is lost. When the device user does attempt to use the SRW device that previously lost connectivity, the device owner is unaware that connectivity, or even the SRW device itself, is or may have been lost.

To ease the task of maintaining connectivity between SRW devices, applications have been augmented to attempt to re-establish the connection. In some instances, status messages and icons regarding SRW connectivity are displayed on the primary device side of the connection, such as on a mobile phones, to indicate that a connection with a paired device, such as a headset, has been lost.

However, such applications do not actively alert SRW devices' holders/users that connectivity to one or more SRW devices has been lost. In particular, should a SRW device be lost or left behind at a location of last usage, the device owner/user would not quickly be aware of this event. To enhance the recovery of a misplaced SRW device, U.S. published patent application no. 2008/0125040 discloses a system that enables users to instruct a master SRW device to communicate with one or more slave SRW devices, which in turn can guide the user to the location of the slave SRW device. This method requires that both master and slave devices to be paired and connected during the recovery process. Thus, this method and system can guide a user to the location of a connected SRW device, should the user become unaware of the device's location while it remains connected to the master device. The system and method of U.S. published patent application no. 2002/0094778 focuses on the quality of the SRW connection and assists a user in achieving optimal placement of individual devices. What neither of the above systems address is the actually event of connectivity loss with an SRW device as the connectivity loss occurs. Consequently, neither of the above systems addresses the potential loss of an SRW device itself when connectivity of the SRW device is lost.

Further limitations and disadvantages of related art will become apparent to one of ordinary skill in the art, through comparison of such systems with some aspects of the present invention as set forth in the remainder of the present application with reference to the drawings.

### SUMMARY OF THE INVENTION

The present invention provides a method and system for triggering alerts or notifications on a primary device as soon as connectivity between two or more paired SRW devices has been lost. In this way, user of the device is immediately notified that a paired device is out of SRW range and that it may have been inadvertently misplaced or left behind. Thus, possible recover of the SRW device is enhanced and the possible loss of the SRW device is decreased.

The primary device may be a master device paired, using one of a variety of SRW communication technologies, protocols or standards (such as BLUETOOTH®) with one or more secondary or slave devices. When enabled by a user, if loss of connectivity between SRW devices is detected, the system triggers one or more alerts on the primary device or on multiple device(s). For example, the primary device can be triggered to emit an aural, physical and/or visual alert to warn the device user that connectivity with a paired slave device, such as a headset, has been lost.

In one aspect of the invention, a system is provided for detecting the loss of connectivity between paired devices that utilize short range wireless communication technology. The system comprising: a master device configured to communicate with multiple slave devices via short range wireless communication technology; at least one slave device configured to communicate with the master device via short range wireless communication technology; and wherein the system is configured to designate both all of the slave devices and less than all of the slave devices as a device of interest, the system further being configured to determine a connectivity status between the master device and the device(s) of interest and to trigger an alert on the master device when the connectivity status between the slave device(s) of interest and the master device changes from connected to not connected, the alert on the master device being of a type that is at least one of aurally, visually, or physically perceivable by a user of the master device.

In another aspect of the invention, a method is provided for detecting the loss of connectivity between paired devices that utilize short range wireless communication technology. The method comprises the steps of: providing a master device configured to communicate with multiple slave devices via short range wireless communication technology; designating at least one slave device as a device of interest; determining connectivity status between the master device and the device(s) of interest; triggering an alert on the master device when connectivity status between the master device and the device(s) of interest changes from connected to not connected; and wherein the alert is of a type that is at least one of aurally, visually, or physically perceivable by a user of the master device.

### BRIEF DESCRIPTION OF THE DRAWINGS

The above and other features of the present invention, its nature and various advantages, will be more apparent upon consideration of the following detailed description, taken in conjunction with the accompanying drawings, of which:

FIG. 1 schematically illustrates an alert system embodying the principles of the present invention;

FIG. 2 shows flow diagram of one exemplary SRW alert setup process, in accordance with the principles of the present invention;

FIG. 3 shows a flow diagram of exemplary SRW monitoring process, in accordance with the principles of the present invention;

FIG. 4 shows a block diagram of exemplary SRW alert database, in accordance with the principles of the present invention; and

FIG. 5 illustrates a system of paired devices embodying the principles of the present invention.

### DETAILED DESCRIPTION

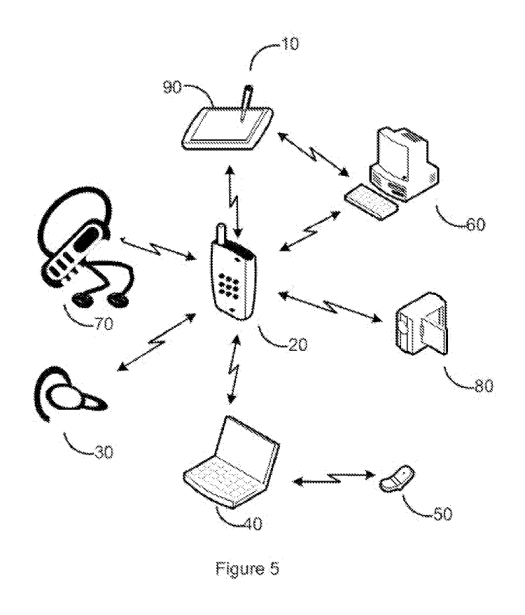

According to various aspects of the present invention, methods and apparatuses are provided for actively generating alerts to a user once connectivity is lost between paired SRW devices in an ad-hoc network of devices, such as that seen in FIG. 5. As seen in FIG. 5, the ad-hoc network (10) includes a primary device (20), such as a mobile phone, smart phone, or PDA, and a number of paired devices with which it communicates via a SRW communication technology. Such paired SRW devices may take many forms, including without limitation, a wireless headset (30), a laptop computer (40), a wireless mouse (50), a desktop computer (60), a portable music player (70), speakers (80), and a wireless keyboard (90).

The alerts are triggered on the primary device (20) to notify its user that connectivity to a designated SRW device has been lost. In achieving the above, the primary device user designates one or more the SRW devices as a device of interest. This is done by selecting the device from a list of SRW devices associated with the primary device (20). The list, which may be provided in the form of a drop down list on the primary device's display screen, is populated by looking up all paired SRW devices registered on the primary device (20). For each SRW device of interest, either a default alert method or a custom alert method is chosen. A variety of alert methods are envisioned, including without limitation, visual, auditory and vibratory alerts. In addition, the alert can cause or trigger, based on availability and selection within the device, the sending of an email/SMS/MMS message, with date/time stamps and global positioning satellite (GPS) location information, or it may maintain this information locally on the device itself for later inspection or use. Any of these alert methodologies may for either the default or one of the custom alert methods.

Once designated, the user's selection of the SRW devices of interest and their associated alert methods are saved in a user preference file that resides either on the primary device (20) or on another device that is accessible to the primary device (20) using one of the variously known communication protocols. During operation, a process running on the primary device (20), preferably as a background process, reads and parses the user's preferences and, as appropriate, generates and/or sends alerts.

For devices that support SRW global system events and expose SRW connectivity events, the background process intercepts events associated with the SRW devices of interest and generates alerts accordingly. As used herein, global system events are alerts that alerts raised/triggered by the operating/host system, before, during or after the execution of a process or task. Sample global events include, but are not limited to, a new device being connected to a master device, a call being received or terminated, or a connection being lost. Most operating systems us a global listener to intercept and raise those events. The events are in turn utilized by one or more applications. Various SRW devices also accommodate connectivity events, which are alerts raised when connectivity between a master device and a slave device is either established or lost. For devices that do not support global system events or do not expose connectivity events, the background process polls each connected SRW device of interest at a pre-determined interval. If polling fails to establish that a connection exists between the primary device (20) and a device of interest, an alert is then triggered with the primary device (20).

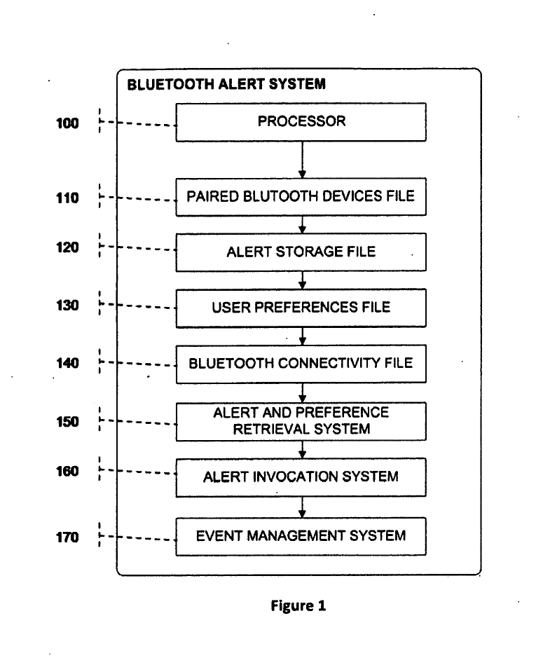

Referring now to FIG. 1, an SRW alert system (99) is illustrated therein and includes a processor (100) that, along with the other components of the system (99), resides on either the primary device (20) or another device in communication with the primary device (20), such the desktop or host computer (60). The SRW alert system (99) includes a paired device file (110) where a list of SRW paired devices is stored. This paired device file (110) includes the device identification addresses for all devices paired with the primary device (20), whether then connected with the primary device (20) or not. The SRW alert system (99) also includes an alert storage file (120) that includes a list indentifying all of the alert methodologies available on the primary device (20). As noted above, these methodologies may include, without limitation, visual, auditory and vibratory alerts. Another file employed by the SRW alert system (99) is a user preference file (130). The user preference file (130) stores the preferences of the primary device user for the alerts assigned to each SRW device of interest.

An SRW connectivity file (140) operates as a repository where active SRW connections are stored during operation of the primary device (20). Non-active connections of paired SRW devices of interest are not stored in this file (140). It is only when an active SRW connection is established between the primary device (20) and one of the SRW devices of interest, that the active connection is stored in the SRW connectivity file (140). The active connections with the SRW devices of interest are thus the connections that will be monitored by the SRW alert system (99).

The above mentioned files (110), (120), (130) and (140) reside on the primary device (20) as stored files, and once set up or initialized or set up, are available for use by the SRW alert system (99) during operation and actual monitoring thereby.

The alerts and preferences retrieval system (150) is invoked upon startup of active monitoring by the alert system (99). In doing so, the contents of the SRW connectivity file (140) and the user preference file (130) are retrieved by the alerts and preferences retrieval routine/system (150). This process instructs the system (99) on which events to process and what alerts to trigger. The system further includes an alert invocation system (160), which is activated by the alert and preference retrieval system (150). More specifically, the alert invocation system (160) generates and invokes alerts based on the occurrence of one or more system events. The invoked alerts can come in various forms based on the user's preferences. The primary purpose of invoking alerts is to communicate to the user a sudden change in system status. When a determination is made that an alert should be triggered, it is this system (160) that fires the alerts based user preferences provided to it by the alert and preference retrieval system (150). Also provided in the SRW alert system (99) is an event management system (170). The event management system (170) is a system that enables a user to store, manipulate and manage events invoked by the operating system. It embodies the intelligence to filter and/or select events that are of interest to the user. As such, it filters and processes various events associated with the SRW devices of interest.

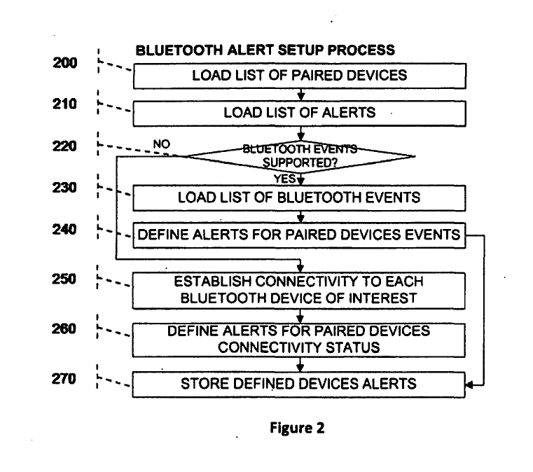

The first step (200) of the alert setup process, this process being set out in FIG. 2, is to load the list of paired SRW devices from the paired devices file (110) stored on the primary device (20). This file contains the unique device identification number for each SRW device that's paired with the primary device (20). At this stage of the setup process, a paired slave device may or may not be actively connected to the primary device (20). In step (210), the process of loading the list of alerts from the alert storage file (120) on the master device in undertaken. This list can widely vary between the various primary and slave devices. While some devices may support audible, visual, and vibratory alerts, others may only support audible and visual alerts, or just one of those alerts.

Next, in step (220), the process detects whether the primary device (20) supports and exposes global system events.

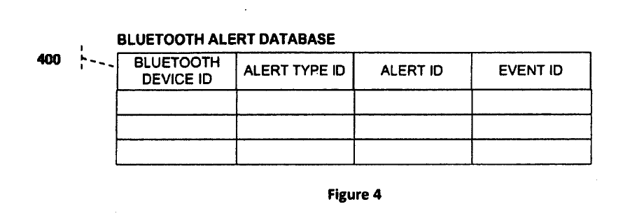

If such support is available from the primary device (20), then the primary device (20), and the system itself, can subscribe to and filter the desired events that pertain to the SRW devices of interest. In the situation where global system events are supported and exposed by the primary device (20), the subscribed to global system events are loaded in step (230). In step (240), the process defines and assigns one or more alerts for each event of the SRW devices of interest. In the present example, the event is an indication of a loss of connectivity to a paired SRW device of interest. Once the alerts are defined and assigned, in step (270) the process stores the final alert configuration in the user preference file (130). The alert configuration may be stored in the form of the alert configuration schema (400) depicted in FIG. 4. This alert configuration schema (400) presents a non-limiting embodiment in which the system stores the identification (ID) of the SRW device of interest, the alert type ID, the event ID and the alert ID. The event ID is the actual loss of connectivity. The alert ID is the alert that would be triggered should the event (the loss of connectivity with the SRW device of interest) occur. In this example, only one event ID is used.

Referring back to step (220), if global system events are not supported, then the process proceeds to step (250). In step (250), the process establishes SRW connectivity to each SRW device of interest. As noted by step (220), this process step (250) is only enabled in the situation where global system events are not supported or exposed by the primary device (20). Next, in step (260), one or more alerts are assigned for the loss of connectivity of each actively connected device of interest. Once the alerts are defined and assigned, the process proceeds to step (270) and the final alert configuration is stored in the user preference file (130), generally in accordance with the alert configuration schema (400) mentioned above and depicted in FIG. 4.

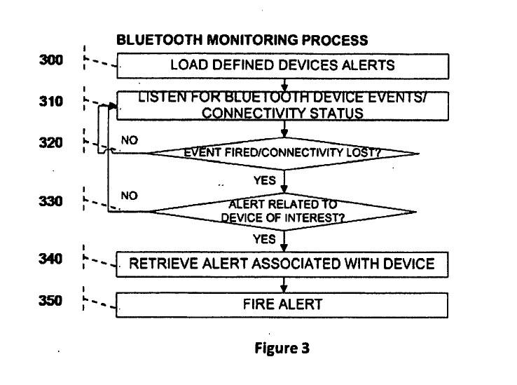

Referring now to the process generally depicted in FIG. 3, step (300) is the first step of the SRW monitoring process. Step (300) begins the process by loading the stored list of defined alerts (270) from the alert storage file (120), which again is preferably stored on the primary device (20), but may be stored in a shared location (host device) accessible by the primary device (20). Next, in step (310), the process monitors the connectivity status between the primary device (20) and each SRW device of interest, or between various SRW devices of interest themselves. This is achieved either by listening for global system events or by testing the connection between devices at a frequent and predefined testing interval. Preferably, but not necessarily exclusively, the monitoring process of FIG. 3 and the above mentioned steps would start upon booting up of the primary device (20) and would continuously run as a background process on the primary device (20). In step (320), the process that detects whether a global system event has occurred or whether the connectivity to one or more of the various paired devices has been lost. If it is determined, in step (330), that the detected global system event or lost connection does not pertain to an SRW device of interest, that event is ignored and no alert is triggered. On the other hand, should the detected global system event or lost connection pertain to an SRW device of interest, then, in step (340), the alert(s) associated with the device of interest and assigned to this event is retrieved and loaded into the alert invocation system (160). In step (350), all of the loaded alerts are then triggered by the system and outputted to the user by the primary device (20).

As mentioned above, a variety of alerts may be triggered and these include visual, audible or vibratory alerts. By way of example, a visual alert may take the form of message on the screen of the primary device (20), an audible alert the form of a tune being played by the primary device (20), and a vibratory alert the form of a vibration signal emitted by the master device. In another example, this system may trigger both an audible alert, such as a sound, and a visual alert, such as a display message when connectivity is lost to an SRW device of interest. Alternatively, the alert invocation system (160) could send the alert(s) to one or more devices other than or in addition to the primary device (20), which in turn would emit audio, visual, or vibratory alerts.

As a person skilled in the art will readily appreciate, the above description is meant as an illustration of implementation of the principles this invention. This description is not intended to limit the scope or application of this invention since the invention is susceptible to modification, variation and change, without departing from spirit of this invention, as defined in the claims.

I/We claim:

1. A system for detecting the loss of connectivity between paired devices that utilize short range wireless communication technology, the system comprising:
a master device configured to communicate with multiple slave devices via short range wireless communication technology;
at least one slave device configured to communicate with the master device via short range wireless communication technology; and
wherein the system is configured to designate both all of the slave devices and less than all of the slave devices as a device of interest, the system further being configured to determine a connectivity status between the master device and the device(s) of interest and to trigger an alert on the master device when the connectivity status between the slave device(s) of interest and the master device changes from connected to not connected, the alert on the master device being of a type that is at least one of aurally, visually, or physically perceivable by a user of the master device.

2. The system of claim 1 wherein system is configured to allow the user to select the type of the alert triggered on the master device.

3. The system of claim 1 wherein system is configured to allow the user to independently select the types of the alerts triggered on the master device for each device of interest.

5. The system of claim 1 wherein preferences of the user as to devices of interest and types of alerts are stored in a shared location and accessible by both the master device and the slave device.

6. The system of claim 1 wherein the master device is one of a mobile phone, a smartphone, a personal digital assistant, and a portable electronic device configured to provide alerts to a user thereof.

7. The system of claim 1 wherein the slave device is one of a wireless headset, speakers, keyboard, mouse, laptop computer, desktop computer and portable music player.

8. The system of claim 1 wherein the system is configured to monitor of global system events in determining connectivity status between the master device and device of interest.

9. The system of claim 1 wherein the system is configured to monitor an established short range wireless connection in determining connectivity status between the master device and device of interest.

10. The system of claim 1 wherein the alert includes the sending one of an email, SMS, and MMS communication including date, time and location information.

11. A method for detecting the loss of connectivity between paired devices that utilize short range wireless communication technology, the method comprising:
providing a master device configured to communicate with multiple slave devices via short range wireless communication technology;
designating at least one slave device as a device of interest;
determining connectivity status between the master device and the device(s) of interest;
triggering an alert on the master device when connectivity status between the master device and the device(s) of interest changes from connected to not connected; and
wherein the alert is of a type that is at least one of aurally, visually, or physically perceivable by a user of the master device.

12. The method of claim 11 further comprising the step of providing a menu containing a list of all slave devices paired with the master device and whereby a user may designate more than one slave device as a device of interest.

13. The method of claim 11 further comprising the step of providing a menu whereby a user may select at least one type of alert for each device of interest.

14. The method of claim 11 further comprising the step of saving user preferences as to the device(s) of interest and the type of alert to be triggered for each device of interest upon the device of interest changing from connect to not connected with the master device.

15. The method of claim 11 wherein the designating step enables the user to designate either all of the slave devices as a slave device of interest or less than all of the slave devices as a slave device of interest.

16. The method of claim 11 wherein the step of determining connectivity status identifies an established short range wireless connection between the master device and a slave device.

17. The method of claim 16 further comprising, after the step of identifying the established short range wireless connection between the master device and the slave device, periodically polling the slave device to determine if the connectivity status changes from connected to not connected.

18. The method of claim 17 further comprising the step of determining if the changed connectivity status relates to a device of interest and ignoring the changed connectivity status if it does not relate to a device of interest.

19. The method of claim 11 wherein the step of determining connectivity status scans for global system events associated with the device(s) of interest.

20. The method of claim 11 wherein the executable commands of the method reside on memory in the master device.

21. The method of claim 11 wherein the executable commands of the method reside on memory in a device remote from but accessible by the master device.

22. The method of claim 11 wherein the alert includes the sending one of an email, SMS, and MMS communication including date, time and location information.
